(19) United States
(12) Patent Application Publication
(10) Pub. No.: US 2025/0319425 A1
(43) Pub. Date: Oct. 16, 2025

(54) SKIMMER DEPLOYMENT SYSTEM

(71) Applicant: Ross DAVIS, Houston, TX (US)

(72) Inventor: Ross DAVIS, Houston, TX (US)

(21) Appl. No.: 19/066,363

(22) Filed: Feb. 28, 2025

Related U.S. Application Data
(60) Provisional application No. 63/634,597, filed on Apr. 16, 2024.

(51) Int. Cl. B01D 17/02; B62B 3/02; B62B 5/00; C02F 1/40; C02F 101/32; C02F 103/10

(52) U.S. Cl. CPC B01D 17/0214; B62B 3/02; B62B 5/00; C02F 1/40; B62B 2206/003; C02F 2101/32; C02F 2103/10; C02F 2201/008

(57) ABSTRACT

Systems, devices and methods for deployment of skimmer devices used for recovery of a less dense fluid floating over a denser fluid within a containment area utilize a cart mounted skimmer tethered to a vehicle.

### CROSS REFERENCE TO RELATED APPLICATIONS

This application claims priority and benefit from U.S. Provisional Patent Application No. 63/634,597 filed on Apr. 16, 2024, entitled “Skimmer Deployment System,” the content of which is hereby incorporated in its entirety herein by reference.

### BACKGROUND OF THE INVENTION

### Technical Field

Systems, devices and methods for deployment of skimmer devices used for recovery of a less dense fluid floating over a denser fluid within a containment area.

### Discussion of the Background

Production operations in the oil and gas industry is the term which generally refers to the stage at which the hydrocarbons are drawn from the subsurface. Once at the surface, the material is transferred, treated and stored at the well site location or in a field installation for future transport to a refinery or pumping station. Many oil fields produce at certain times a multiphase fluid which may be a mix of saltwater and oil which needs to be separated and disposed of properly to avoid surface and groundwater contamination.

As part of the process of separation and treatment of the saltwater-oil mix, some amount of oil may accumulate in tanks designated as saltwater tanks and needs to be removed. The fluid is generally collected at a central station including one or more saltwater tanks. From here, the saltwater may be picked up and transported to another location for disposal which typically is a well specifically designed to accept saltwater waste fluids. Alternatively, the saltwater fluid produced at the field level may be directly connected to a saltwater disposal well located onsite. In this case, the saltwater is typically transferred via a pipeline or gathering lines running from the saltwater tanks to the disposal well and the waste saltwater is then pumped into a subterranean formation permitted for that purpose.

It is deleterious to the permeability of the injection zone in which the waste saltwater flows to have contaminants in the saltwater fluids. Contaminants could include organic material, precipitated solids, oil, or oil by-products. Thus, the removal of oil from the saltwater stored in the saltwater tanks is important so that no oil is injected which could reduce the injection zone's capacity in the saltwater disposal well.

Further, contaminants and precipitates formed in the oil can cause damage to injector pumps and related equipment used for saltwater disposal purposes. Damage to the equipment and reduced saltwater well injection capacity from oil and other oil contaminants pumped into a disposal well results in higher cost of production for oil and gas operators. In addition, waste saltwater can be produced in such large volumes that storage capacity is limited, and contaminant oil thus take up valuable volume and add costs. Also, malfunctions of equipment and sensors can result in spills and spillovers of liquids stored in saltwater tanks including oil which then require cleanup at the tank secondary containment area, commonly referred to as the “firewall” or other areas outside the containment area. In certain states, spills over a certain amount must be reported to the applicable regulatory agency which could result in fines and other penalties.

Currently, if saltwater in a storage tank is contaminated with an oil layer, or an oil-water mix is spilled into a containment or other area, specialized personnel and pumper trucks are required to remove and dispose the contaminated fluid from the tank, firewall or other area. This is a costly and time-consuming process.

FIG. 1 illustrates a skimmer apparatus deployed within a holding tank's 200 secondary containment region 205 (i.e., the “firewall”) typically bordered by a wall or earthen berm 340. The containment region 205 is intended to contain a spill or overflow of fluid from tank 200. Mobile skimmer assembly 100 includes skimmer vessel 105 coupled to a manually operated or powered (i.e., motor-driven, pneumatically, or hydraulically) adjustable height mechanism 305 is connected to a static anchor or base member 330 which affixes assembly 100 within region 205. A manually operated version of skimmer vessel assembly 100 includes an adjustable height mechanism 305 which relies on a jack handle 320 is shown in the example of FIG. 1. The mobile skimmer assembly 100 is thus deployed into containment region 205 which contains e.g., a two-layer body of fluid comprising an oil layer 230 atop a volume of water 240. One drawback to this approach of skimming contaminant oil is that the skimmer assembly needs to be manually deployed by an operator or lowered into the area by a boom. Deployment of the assembly thus requires special gear and can be an expensive and time-consuming process. Therefore, there is a need for a simplified system to safely and efficiently deploy a skimmer apparatus into a containment area.

### SUMMARY OF EXAMPLE EMBODIMENTS

According to an embodiment, there is a separator assembly for removing a volume of a less dense fluid from the top of a denser volume of fluid. The assembly includes a vessel configured to contain a fluid with a closed bottom and a top open to receive fluid into the vessel; a cart for transporting the vessel; and a connector arm coupled to the vessel at one end and to a pivot point on the cart at the second end. The vessel angularly rotates about the pivot point to maintain a level position when the cart is positioned on an incline.

According to another embodiment, there is a separator assembly for removing a volume of a less dense fluid from the top of a denser volume of fluid. The assembly includes a vessel configured to contain a fluid with a closed bottom and a top open to receive fluid into the vessel; a cart for transporting the vessel; a connector arm coupled to the vessel at one end and to a pivot point on the cart at the second end; a pump in fluid communication with the vessel; and a fluid conduit having an intake position within the vessel. When the separator assembly is in use, a volume of less dense fluid from on top a denser fluid flows into the vessel and the less dense fluid is pumped out of the vessel by the pump via the fluid conduit.

According to yet another embodiment, there is a separation system for removing a volume of a less dense fluid from the top of a denser volume of fluid located in a containment area. The system includes a separator assembly comprising a vessel configured to contain a fluid with a closed bottom and a top open to receive fluid into the vessel; a cart for transporting the vessel; a connector arm coupled to the vessel at one end and a pivot point on the cart at a second end; a pump in fluid communication with the vessel; a fluid conduit having an intake position within the vessel; a tether affixed to the cart; a spool or winch for extending the cart into a containment area; a collection tank; and a discharge conduit configured to discharge fluid from the vessel to the collection tank. When the separator system is in use, a volume of less dense fluid from on top a denser fluid from the containment area flows into the vessel and the pump transfers the less dense fluid out of the vessel and into the collection tank.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows a prior art deployment of a skimmer vessel in a containment area.

FIGS. 2A and 2B show two views of a skimmer assembly.

FIG. 3 shows a skimmer assembly including a static base plate and height adjustment assembly.

FIG. 4 shows a skimmer assembly mounted to an embodiment of a mobile deployment system.

FIG. 5 shows a skimmer assembly mounted to another embodiment of a mobile deployment system.

FIG. 6 shows a skimmer deployment system deployed in a containment area.

### DETAILED DESCRIPTION OF EXAMPLES OF THE INVENTION

The following description of the embodiments refers to the accompanying drawings. The same reference numbers in different drawings identify the same or similar elements. The following detailed description does not limit the invention but is intended to provide exemplary description of devices, systems and methods. The following embodiments are discussed, for simplicity, with regard to devices, systems and methods to deploy a skimmer apparatus to remove a low-density fluid from atop a higher density fluid.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. The drawings are intended to be illustrative of the claimed features and unless stated otherwise are not to scale. Where a dimension of a given feature may be pertinent, the detailed description will indicate one or more examples of the range and units of said dimension where needed to enable the subject matter. Further, the described features, structures or characteristics may be combined in any suitable manner in one or more embodiments.

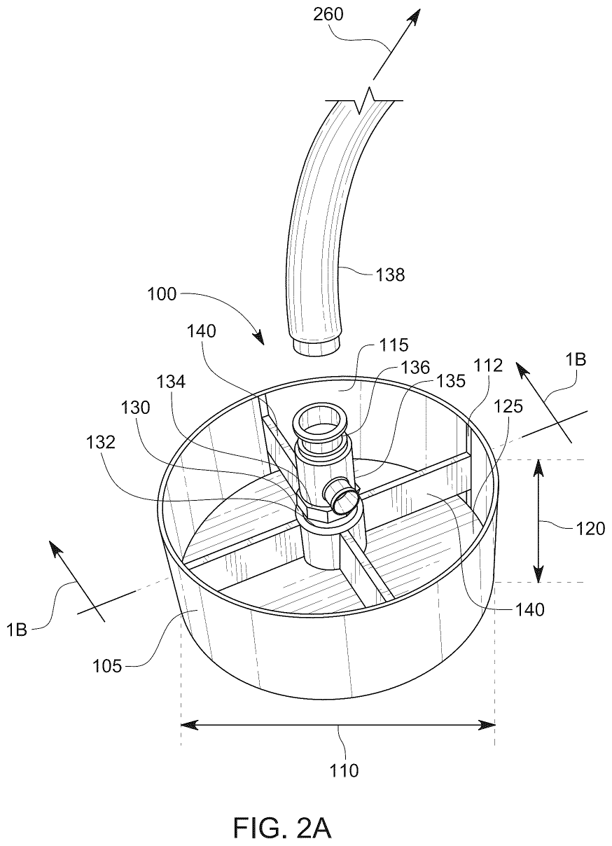

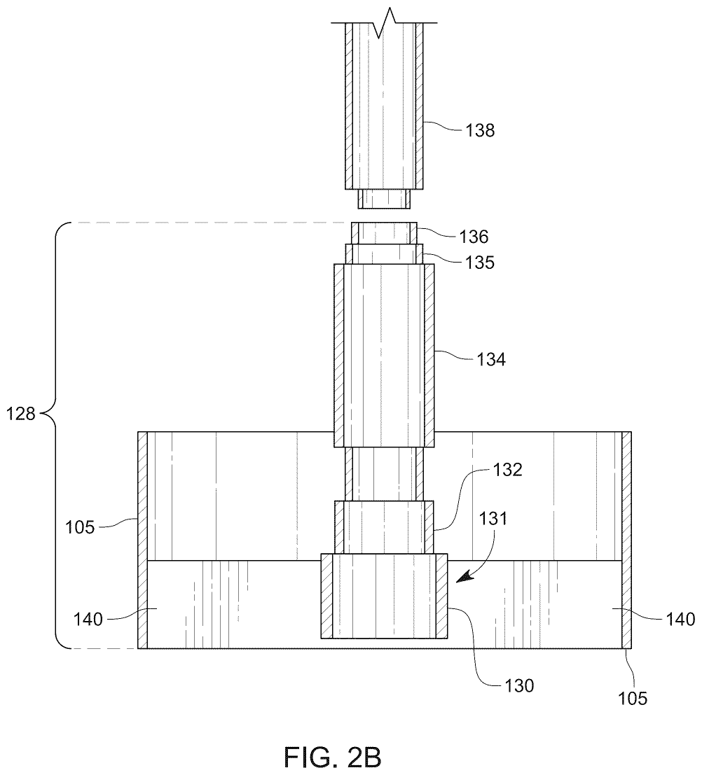

U.S. Pat. No. 11,478,729 and pending U.S. Patent Application Publication US2023/0014402 are owned by the current applicant and are incorporated herein for all purposes. Both are entitled, “Separation Apparatus, System and Method of Use” and disclose mobile devices, systems and methods of removing a less dense fluid from a denser fluid such as contaminant oil floating atop a volume of water. An exemplary skimmer for removing a less dense fluid from a denser fluid is reproduced as FIGS. 2A and 2B which show the main components of a skimmer apparatus 100. In this embodiment, the vessel of skimmer apparatus 100 is comprised of a cylindrically shaped main body 105 comprised of a shell of a scalable diameter 110 and height 120 with a closed bottom 125 and open top. For example, an easily portable unit may be 6-18 inches in diameter and 12 inches in height, though other sizes are readily contemplated and scaled depending on the application such as the volume of fluid to be separated. Thus, in other examples, a vessel may be 2 or 3 feet in diameter or larger. For purposes of this disclosure, the skimmer vessel 100 will be referred to herein simply as “vessel”, “skim vessel” or “skimmer vessel,” but may interchangeably be referred to as a “basket”, “bucket”, “cylinder”, “skimmer”, “skim bucket” or “skimmer bucket”, “weir” or other similar term as commonly used in the field of separator devices.

In general, two or more radial support arms 140 positioned within vessel 105 may intersect to fix a first conduit's 130 position within the center of main body 105. For example, in the embodiment as shown in FIG. 2A, four support arms 140 are shown which may be comprised of steel, metal alloy, plastic or other composite material and extend radially inward from one point on an inner wall 115 to an outer wall central first conduit 130. The arms 140 may be welded to the inner wall 115 of main body 105 which itself may be steel or the same or similar alloy or other material as the support arms 140. Connection of support arms 140 to an outer wall of first conduit 130 is typically by weld. In other embodiments the vessel may be made of plastic or other composite material to reduce weight and molded as a single unit or more than one piece to be fitted together. Regardless of construction material, support arms 140 may be attached to main body 105 and first conduit 130 by means other than welding, for example, with screws or other type mechanical connections such as J-locks, threads, pins, snap fits or other means. In another embodiment, the inner wall 115 may include slots 112 as shown in FIG. 2A. In other embodiments, main body 105 inner wall 115 may include fins that are slotted, and which can receive ends of the support arms 140 affixed to the slotted fins with wing nuts or other connectors. This allows raising or lowering the support arms 140 and first conduit 130 within the main body 105.

As shown in FIGS. 2A and 2B, first conduit 130 is positioned within the interior of main body 105 by radial support arms 140. Conduit 130 may be comprised of a cylindrical body with a through passageway for flow of material, for example, as a short section of pipe or a ring with threads capable of further connection to another component, or a “stack” of connected components. In preferred embodiments, support arms 140 and first conduit 130 are fixed at a predetermined height within main body 105. In one non-limiting example, first conduit 130 may be radially centered and fixedly positioned vertically such that the bottom end of first conduit 130 is located at 5 inches from the top (or 1.5 inches from the bottom) of main body 105 with a height of 6.5 inches. However, as discussed above, support arms 140 may be raised or lowered to provide for height adjustability of first conduit 130 positioned with main body 105.

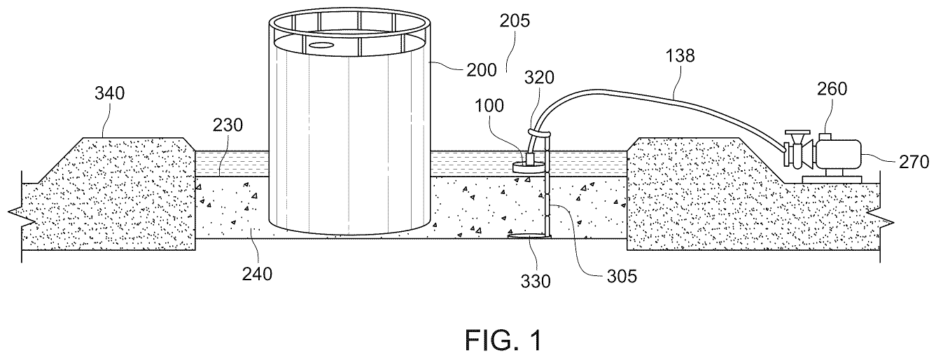

Referring to FIG. 2B, a connection stack 128 may typically be included as part of the apparatus for connecting skimmer vessel 100's first conduit 130 to a hose or second conduit 138. First conduit's 130 upper end may, for example, include an upper threaded end for mechanical coupling, or a threaded nipple or other threaded or snap connecting type fitting, e.g., a quick connect fitting to provide connection to one or more additional components. For example, as shown in the apparatus of FIG. 2B, threaded nipple 132 is connected via female threads to the upper mechanical coupling 131 male threads located on the upper end of first conduit 130. A check valve 134 is then attached, then a third threaded nipple 135, followed by cam lock 136, all of which are provided as a connection stack 128 to affect connection to second conduit 138, which in this example is in the form of a flexible inlet hose. Second conduit 138 is then connected to a distant cam lock (not shown) or other connector for eventual connection to a pump 260 as shown in FIG. 1.

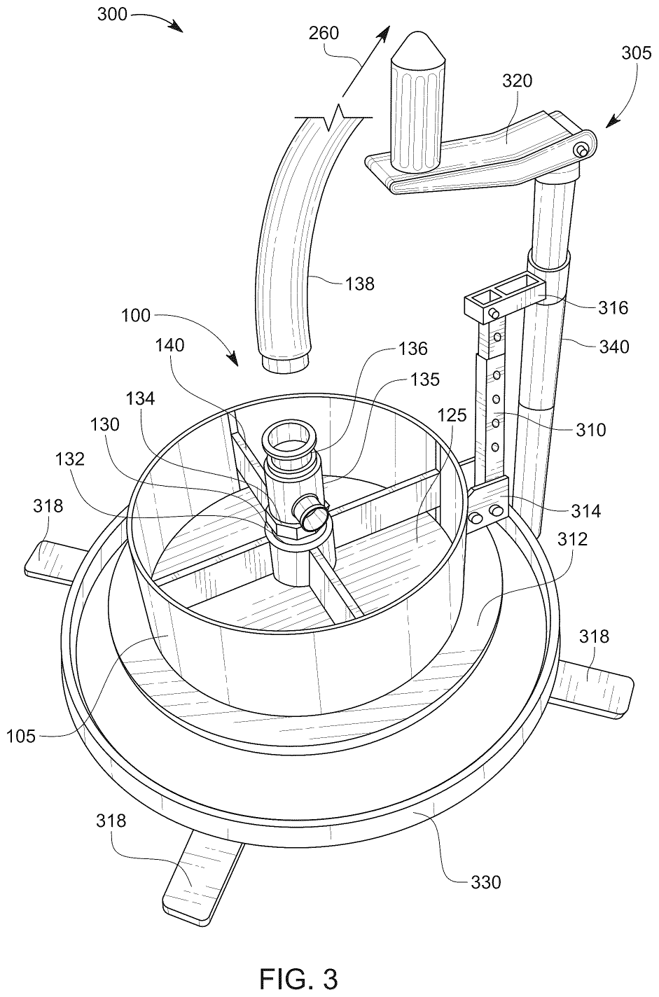

Within a tank's secondary containment region 205 (i.e., the “firewall”) which is intended to contain a spill or overflow of fluid; a statically positioned skimmer vessel assembly 100 may be coupled to a manually operated or powered (i.e., motor-driven, pneumatically, or hydraulically) adjustable height mechanism 305 as shown in FIG. 3, which is connected to an anchor or base member 330. In this embodiment, a manually operated, mechanical height adjustment mechanism 305 is coupled to and supports skimmer vessel 100. Height adjustment mechanism 305 includes a platform 312 for supporting vessel 100. Platform 312 is attached to a vertical member 310 of mechanism 305 and extends upward from a base plate 330 that serves as weighing or anchoring plate to the ground or floor of the area the assembly is deployed.

Vertical member 310 is mechanically coupled to the (ratcheting or gear type) jack 340, through an upper connector 316 and a lower connector 314. Vertical member 310 is in turn fixedly attached to base plate 330. When the ratcheting jack 340 is actuated by rotation of handle 320 a gear member (not shown) within vertical member 310, raises or lowers the platform 312 that supports skimmer vessel 100. Note that vessel 100 may be fixedly attached to platform 312. Vertical member 310 may be cylindrical, or a box shaped vertical pipe element as, for example, a ratcheting jack with stand where the height of platform 312 is adjusted manually via rotating or pump type handle 320 (rotating type shown). Of course, the height adjustment can also be effectuated using any other mechanical mechanism that lifts or lowers assembly 316, 310 and 314 relative to base plate 330 thereby raising or lowering the platform 312.

Height mechanism 305 of skimmer assembly 300 includes a fixed or detachable base plate member 330 that may be equipped with footings 318, and that may be seated or permanently anchored to the ground or floor of a containment region such as the bottom of a firewall. Alternatively, base plate 330 may not be affixed permanently to a floor thus making assembly 300 portable and mobile. In this deployment approach, base plate 330 serves as a weighing or stabilizing member allowing assembly 300 to be readily re-positioning as needed. Base plate 330 is also preferably of sufficient mass itself or may accommodate add-on weights to prevent floatation of the assembly 300 supporting skimmer vessel 100.

However, when the system is manually deployed, the system including the skimmer vessel 100 with height adjustment mechanism 305 and base plate 330 needs to be deployed and height adjusted by an operator. Alternatively, the skimmer may be lowered into the area by a long arm or boom, thus deployment of such as system can be inefficient and manual height adjustment difficult.

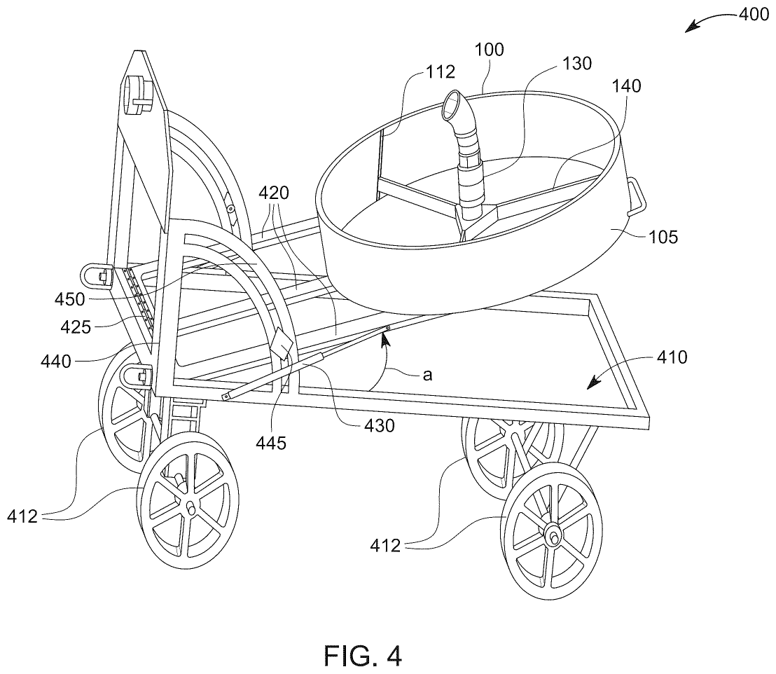

An exemplary separator assembly 400 that is more readily deployable is illustrated in FIG. 4 which shows a mobile skimmer vessel 100 attached to a cart 410 for transportation. As shown, cart 410 includes wheels 412, however, in other embodiments, the cart may include rails, skids, sled or other mobile platform. In this example, vessel 100 is attached to the wheeled cart 410 by connector arms 420 that support vessel 100's main body 105 at a first end and are coupled to pivot point 425 of wheeled cart 410 at the second end. In the example shown in FIG. 4, there are three connector arms 420, though depending on the size of vessel 100, only one or two arms 420 may be sufficient. Also, the pivot point(s) 425 may comprise a single or rotatable connection point for each connector arm or as shown may comprise a hinge to allow rotation of vessel 100. Exemplary dimensions of embodiments of the mobile skimmer vessel 100 of the present deployment system may include a vessel of 36 inches in diameter and a cart of four feet in length as one example; though other sizes of vessel and cart may be necessary depending on the volume of fluid to be separated within a containment region.

In other embodiments, connector arm(s) 420 may be further stabilized by slidably articulating within a guide rail 440 as shown that may optionally include markings 450 to provide an angle dial to determine the angle “a” of the skimmer vessel 100. In additional embodiments, the connection point between the support arms 420 and guide rails 440 may include a wingnut or other fixture to lock the support arms 420 and thus the vessel 100 at a prescribed angle within the guide rail apparatus. In yet other embodiments, connector arms 420 may include one or more dampeners 430 such as hydraulic or pneumatically filled cylinders attached to the arms at a first point and to the cart at the second point to stabilize the vessel during deployment.

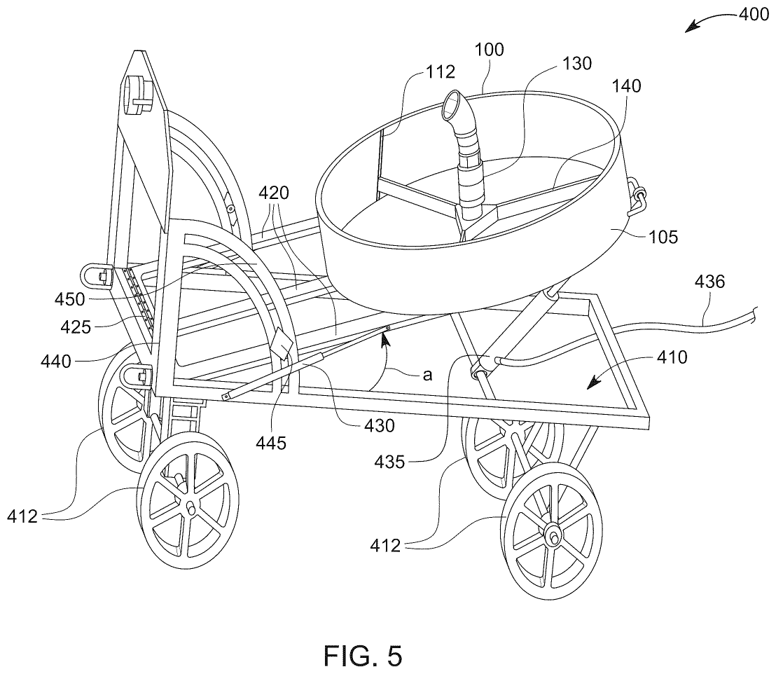

To be discussed in greater detail below, vessel 100's angle “a” relative to the cart 410 may occur as a consequence of its own weight when deployed in a volume of fluid. However, in certain additional embodiments, the setting and adjusting of vessel angel “a” may be actively controlled via actuator arms. FIG. 5 shows one example of an actuator 435 that may be used to adjust and set vessel 100's angle “a”. In this example, actuator 435 is slidably affixed to the rear of vessel 100 and is comprised of a hydraulic or pneumatic piston controlled from outside the containment region 205 via a pump (not shown) that feeds a hydraulic line 436 to actuator 435. Actuator arm 435 may be affixed to vessel 100 at differing locations, but in the example as shown in FIG. 5 it is located at the rear, and thus arm 435 may fold underneath vessel 100 and slidably engage a track underneath the vessel. Actuator arm(s) 435 may also be included as part of the assembly 400 either in replacement of or in addition to passive dampeners 430 and may be of an electromechanical, hydraulic or pneumatic type and controlled by a local pump or motor located on the cart 410 or remotely from assembly 400.

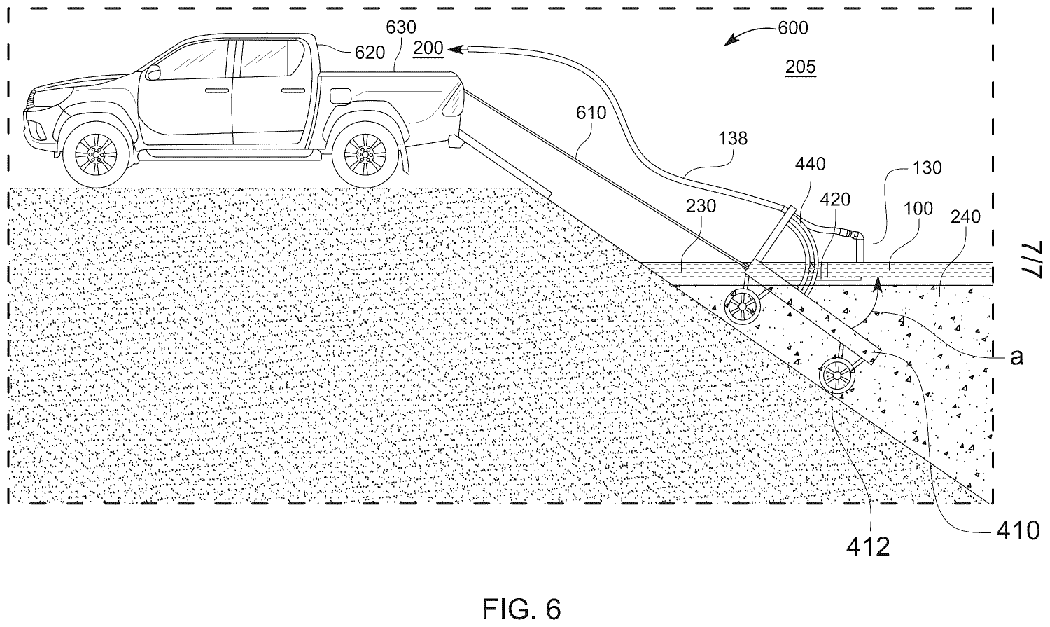

FIG. 6 shows an exemplary separation system 600 with the separator assembly 400 deployed into a secondary containment region 205 contaminated by a volume of oil 230 atop a volume of water 240. In this example, a vehicle 620 (e.g., pickup truck, skid steer, 4-wheeler, etc.) is used to transport the separator assembly 400 to an embankment of the containment area. The skimmer assembly 400 with wheeled cart (410/412) is then lowered in the area via a tethered line 610 connected to a winch 630 (or hand spooled on a reel, etc.) located on vehicle 620. The mobile skimmer is lowered to a desired position within the body of fluid such that the skimmer vessel 100 is located at an angle a relative to the cart 410 as provided by control arm 420 engaged with guide rails 440 as described above. Varying the extension of the tethered line 610, the height of the skimmer 100 is adjusted such that the less dense layer of fluid (e.g., oil atop water) is able to flow into the top of the skimmer vessel 100. Given the buoyancy of vessel main body 105, the assembly's weight is overcome such that the vertical position of vessel 100 relative to the top of the fluid 230 is maintained. In one example, a separator assembly weight may be 350 lb. which produces approximately 225 lbs. of buoyancy. As described above, vessel 100's position may alternatively be actively controlled via an actuator arm 435 (see FIG. 5). In other embodiments, the system 600 may rely upon the extension of tether 610 to roughly set the vessel's position and actuator control to fine tune and maintain the desired position of vessel 100 as the fluid level changes.

Once deployed, the less dense fluid that is to be removed is drawn up a suction pump 260 (not shown) located on the truck 620 or other position outside containment region 205. Less dense fluid 230 is thus drawn into first conduit 130 of vessel 100 and through an extended second conduit 138 to a holding tank 200 which may be located on the same or a second truck 620 or to a tank located outside the containment area 205. Also as described above, in other embodiments, the assembly 400 may include a positive pressure pump located on the cart 410 or even within the main body 105 of vessel 100.

What is claimed is:

1. A separator assembly for removing a volume of a less dense fluid from the top of a denser volume of fluid, the assembly comprising:
a vessel configured to contain a fluid with a closed bottom and a top open to receive fluid into the vessel;
a cart for transporting the vessel;
a connector arm coupled to the vessel at one end and to a pivot point on the cart at the second end; and
wherein the vessel angularly rotates about the pivot point to maintain a level position when the cart is positioned on an incline.

2. The separator assembly of claim 1, further comprising at least one semi-circular guide rail affixed to the cart and mechanically communicates with the connector arm.

3. The separator assembly of claim 2, wherein the at least one guide rail further comprises markings to indicate the vessel angle.

4. The separator assembly of claim 1 further comprising a hydraulic or pneumatic damper arm coupled to the connector arm at one end and to the cart at the second end.

5. The separator assembly of claim 1 further comprising an actuator arm coupled to the connector arm at one end and to the cart at a second end and configured to manually or remotely adjust the vessel angle.

6. The separator assembly of claim 1, wherein the cart is a wheeled cart.

7. A separator assembly for removing a volume of a less dense fluid from the top of a denser volume of fluid, the assembly comprising:
a vessel configured to contain a fluid with a closed bottom and a top open to receive fluid into the vessel;
a cart for transporting the vessel;
a connector arm coupled to the vessel at one end and to a pivot point on the cart at the second end;
a pump in fluid communication with the vessel;
a fluid conduit having an intake position within the vessel; and
wherein when the separator assembly is in use, a volume of less dense fluid from on top a denser fluid flows into the vessel and the less dense fluid is pumped out of the vessel by the pump via the fluid conduit.

8. The separator assembly of claim 7, wherein the pump is affixed to the cart.

9. The separator assembly of claim 7, wherein the fluid conduit's position is vertically adjustable within the vessel.

10. The separator assembly of claim 7, further comprising at least one semi-circular guide rail affixed to the cart and mechanically communicates with the connector arm.

11. The separator assembly of claim 10, wherein the at least one guide rail further comprises markings to indicate the vessel angle.

12. The separator apparatus of claim 7 further comprising a hydraulic or pneumatic damper arm coupled to the connector arm at one end and to the cart at the second end.

13. The separator assembly of claim 7, wherein the cart is a wheeled cart.

14. A separation system for removing a volume of a less dense fluid from the top of a denser volume of fluid located in a containment area, the system comprising:
a separator assembly comprising a vessel configured to contain a fluid with a closed bottom and a top open to receive fluid into the vessel; a cart for transporting the vessel; a connector arm coupled to the vessel at one end and a pivot point on the cart at a second end; a pump in fluid communication with the vessel; a fluid conduit having an intake position within the vessel;
a tether affixed to the cart;
a spool or winch for extending the cart into a containment area;
a collection tank;
a discharge conduit configured to discharge fluid from the vessel to the collection tank; and
wherein when the separator system is in use a volume of less dense fluid from on top a denser fluid from the containment area flows into the vessel and the pump transfers the less dense fluid out of the vessel and into the collection tank.

15. The separation system of claim 14, wherein the pump is affixed to the cart.

16. The separation system of claim 14, wherein the fluid conduit's position is vertically adjustable within the vessel.

17. The separation system of claim 14, further comprising at least one semi-circular guide rail affixed to the cart and mechanically communicates with the connector arm.

18. The separation system of claim 17, wherein the at least one guide rail further comprises markings to indicate the vessel angle.

19. The separation system of claim 14 further comprising a hydraulic or pneumatic damper arm coupled to the connector arm at one end and to the cart at the second end.

20. The separation system of claim 14, wherein the cart is a wheeled cart.
